(19) United States
(12) Patent Application Publication
(10) Pub. No.: US 2025/0370811 A1
(43) Pub. Date: Dec. 4, 2025

(54) WORKLOAD DISTRIBUTION BASED ON NODE PROPERTIES

(71) Applicant: Red Hat, Inc., Raleigh, NC (US)

(72) Inventors: Leigh Griffin, Waterford (IE); Christopher Foley, Waterford (IE)

(21) Appl. No.: 18/675,767

(22) Filed: May 28, 2024

(51) Int. Cl. G06F 9/50

(52) U.S. Cl. CPC G06F 9/5033; G06F 9/505

(57) ABSTRACT

Some examples of the present disclosure relate to workload distribution based on node properties. In one particular example, a system can receive a request to execute a workload on at least one node of a set of nodes. The system can determine, based on the request, an intrinsic property that a node of the set of nodes is to include for executing the workload. The intrinsic property can be independent of the workload. The system can determine, based on the request, an extrinsic property that is to be used by the node to execute the workload. The extrinsic property can be dependent on the workload. The system can determine that a first node of the set of nodes includes the intrinsic property. In response to determining that the first node includes the intrinsic property, the system can execute the workload on the first node using the extrinsic property.

### TECHNICAL FIELD

The present disclosure relates generally to software execution. More specifically, but not by way of limitation, this disclosure relates to distributing workloads based on node properties.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge-computing solutions. Edge computing is a networking philosophy focused on bringing computing power and data storage as close to the source of the data as possible to reduce latency and bandwidth usage. Distributed computing environments may employ edge devices to perform various functions at the edge. Edge devices may be resource constrained and geographically isolated.

### BRIEF DESCRIPTION OF THE DRAWINGS

FIG. 1 is a block diagram of an example of a system for workload distribution based on node properties according to some examples of the present disclosure.

FIG. 2 is a block diagram of an example of a computing environment for workload distribution based on node properties according to some examples of the present disclosure.

FIG. 3 is a flow chart of an example of a process for workload distribution based on node properties according to some examples of the present disclosure.

### DETAILED DESCRIPTION

Edge devices may produce vast amounts of data. Since edge devices, such as Internet of Things (IoT) devices, often have limited processing capabilities and constrained resources, edge devices may face challenges executing complex and computationally intensive workloads. Edge devices in a distributed environment (e.g., cloud network) may further require efficient utilization of strategically placed resources to ensure optimal performance from across the network. But, workloads may not be assigned to an optimal device, leading to overloading the selected device. In addition, workloads may experience inefficient and suboptimal execution.

Some examples of the present disclosure can overcome one or more of the abovementioned problems by providing a system that can distribute workloads based on node properties. The system can receive a request to execute a workload on at least one node of a set of nodes. The system can determine, based on the request, an intrinsic property that a node of the set of nodes is to include for executing the workload. The intrinsic property can be independent of the workload. The system can determine, based on the request, an extrinsic property that is to be used by the node to execute the workload. The extrinsic property can be dependent on the workload. The system can determine that a first node of the set of nodes includes the intrinsic property. In response to determining that the first node includes the intrinsic property, the system can execute the workload on the first node using the extrinsic property. The first node may include the extrinsic property prior to executing the workload, or the system may provide the extrinsic property to the first node at the time of the execution. As a result, the first node may be the most appropriate device for executing the workload, leading to efficient and improved execution of the workload.

As a particular example, a software application may involve requirements of using a shared library and an input dataset. These requirements can be indicated in a request for executing the software application. A system can receive the request and determine which of the requirements are intrinsic properties (e.g., shared properties between nodes of a network and independent of the software application) and which of the requirements are extrinsic properties (e.g., unique properties of a node that are dependent on the software application). The system may perform pattern matching on the requirements to determine that the shared library is an intrinsic property and that the input dataset is an extrinsic property. The system can then determine that node A in a network includes the shared library, so the system can select node A for executing the workload. The system can then execute the software application on node A. If node A does not include the input dataset, the system can provide the input dataset to node A for the execution. Accordingly, the software application is executed on a node that includes minimum requirements (e.g., intrinsic properties) for the execution, resulting in increased efficiency in the execution.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

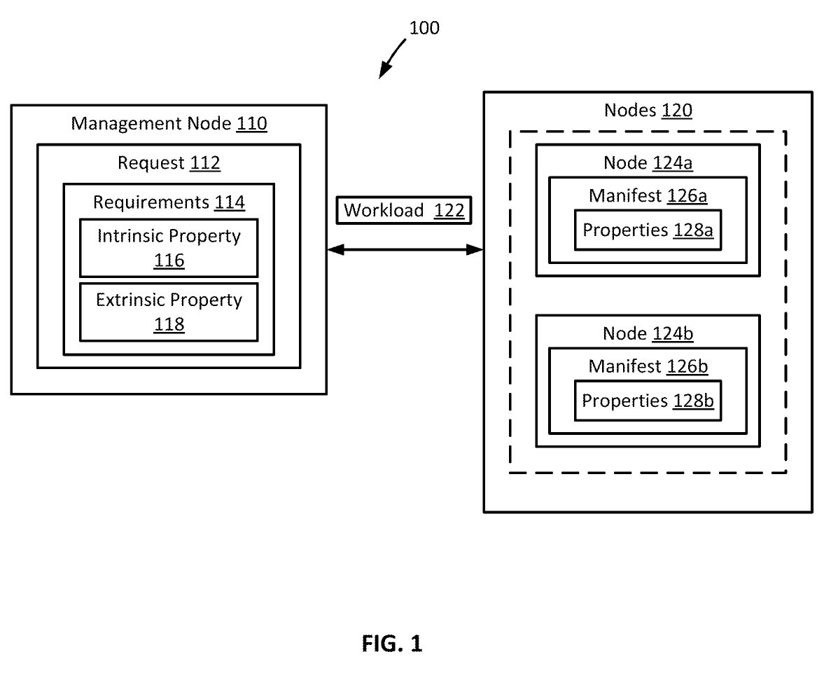

FIG. 1 is a block diagram of an example of a system 100 for workload distribution based on node properties according to some examples of the present disclosure. In some examples, the system 100 may be a distributed computing environment such as an edge computing environment, a cloud computing environment, or a computing cluster. The system 100 can be formed from a management node 110 and one or more nodes 120 (e.g., physical servers, virtual servers, Internet of Things (IoT) devices, etc.) that are in communication with one another via a network, such as a local area network (LAN), wide area network (WAN), the Internet, or any combination thereof.

The system 100 can include the management node 110 that can manage or otherwise communicate with nodes 120. Examples of the management node 110 or of the nodes 120 can include desktop computers, laptop computers, servers, mobile phones, tablets, etc. The management node 110 or the nodes 120 may be edge devices such as Raspberry Pis, sensors, or other resource-constrained, IoT devices. The management node 110 may include a container management platform, such as Kubernetes or OpenShift. As illustrated, the nodes 120 include node 124a and node 124b.

The management node 110 can control execution of a workload 122 (e.g., container or software application) on the nodes 120 based on intrinsic and extrinsic properties. Intrinsic properties are shared properties required by the nodes 120 to execute the workload 122. For example, intrinsic properties may be shared libraries, algorithms, security keys, and resources (e.g., bandwidth, compute resources, memory resources, etc.) needed for executing the workload 122. In other words, the intrinsic properties may be independent of the workload 122. The management node 110 can receive manifests 126a-126b from the nodes 124a-124b that indicate properties 128a-128b of the nodes 124a-124b. The properties 128a-128b can include the shared libraries, security keys, algorithms, and resources that the nodes 124a-124b have. So, based on the properties 128a-128b, the management node 110 can determine the intrinsic properties of the nodes 124a-124b and store the intrinsic properties for each of the nodes 124a-124b. Since the intrinsic properties capture the hardware capabilities, the software capabilities, and the shared resources of the nodes 124a-124b, the management node 110 can develop a full capability matrix for the network.

In addition to intrinsic properties, the management node 110 can also control the execution of the workload 122 based on extrinsic properties, which represent specific information that is associated with an individual workload request. So, the extrinsic properties can be dependent on the workload 122. The extrinsic properties can include configurations, input data for running a workload, a geographic requirement for a workload, a library involved in running a workload, etc. The extrinsic properties for a workload may be indicated in a request for executing the workload.

In some examples, upon the management node 110 receives a request 112 to execute a workload 122 on at least one node of the nodes 120. The management node 110 can then determine an intrinsic property 116 that a node of the nodes 120 is to include for executing the workload 122 and an extrinsic property 118 that is to be used by the node for executing the workload 122. For instance, requirements 114 for running the workload 122 may be indicated in the request 112, and the requirements 114 can include the intrinsic property 116 and the extrinsic property 118. Generally, the requirements 114 can include node requirements and deployable requirements, where the intrinsic property 116 is based on the node requirements and the extrinsic property 118 is based on the deployable requirements. As a particular example, the requirements 114 may indicate a node requirement of a security key and a deployable requirement of a dataset. So, the intrinsic property 116 can be the security key and the extrinsic property 118 can be the dataset. Additionally or alternatively to the requirements 114, the management node 110 may perform pattern matching, use a machine learning model (e.g., a large language model), or keywords or flags included in the request 112 to determine the intrinsic property 116 and the extrinsic property 118.

Upon determining the intrinsic property 116 and the extrinsic property 118, the management node 110 can determine which node of the nodes 120 to execute the workload 122 on based on the intrinsic property 116 and the extrinsic property 118. For instance, since the management node 110 knows the intrinsic properties of the nodes 124a-124b based on the manifests 126a-126b, the management node 110 can determine which of the nodes 124a-124b has the intrinsic property 116 of the requirements 114. As an example, the management node 110 can determine that the node 124a includes the intrinsic property 116 of the security key. Based on the node 124a including the intrinsic property 116, the management node 110 can determine that the node 124a is to execute the workload 122. So, the management node 110 can execute the workload on the node 124a.

In some examples, the execution of the workload 122 can involve using the extrinsic property 118 (e.g., the dataset). So, the management node 110 can determine whether the node 124a includes the extrinsic property 118. If the node 124a includes the extrinsic property 118, the management node 110 can proceed with executing the workload 122 on the node 124a using the extrinsic property 118. If not, the management node 110 can send the extrinsic property 118 to the node 124a prior to executing the workload 122 on the node 124a to ensure that the workload 122 is able to run without encountering an error related to the dataset not being available during the execution.

In some instances, if both of the nodes 124a-124b include the intrinsic property 116, but only the node 124a includes the extrinsic property 118, the management node 110 may determine to execute the workload 122 on the node 124a so that the management node 110 does not also have to provide the extrinsic property 118. In other words, the node 124a may have a higher priority than the node 124b by having the extrinsic property 118. The management node 110 may also use alternate selection criteria for selecting a node for executing the workload 122 if more than one node includes the intrinsic property 116. For example, the management node 110 may select a node based on its geographic location, based on a capacity of the node, or based on a node selection algorithm (e.g., round robin assignment). So, if the node 124a is closer to the management node 110, has a higher capacity than the node 124b, or is the next selection based on the node selection algorithm, the management node 110 can select the node 124a for executing the workload 122 instead of the node 124b even if both of the nodes 124a-124b include the intrinsic property 116.

In some examples, the management node 110 may determine that multiple nodes are to execute the workload 122. For instance, the management node 110 may determine that each of the nodes 120 that includes the intrinsic property 116 is to execute an instance of the workload 122. So, if both of the nodes 124a-124b includes the intrinsic property 116, the management node 110 can execute the workload 122 on both of the nodes 124a-124b. In another example, the request 112 may indicate a number of nodes (e.g., ten) for executing the workload 122. The management node 110 can then select the number of nodes from the nodes 120. Each of the selected nodes can include the intrinsic property 116. Multiple nodes may execute the workload 122 to remove variability in results of the execution and to remove a single point of failure.

In some examples, the workload 122 may be decomposed into smaller tasks based on capabilities of the nodes 120. The tasks can be assigned to appropriate nodes based on the capabilities. The management node 110 can assign priorities to workloads based on time-based needs, Quality of Service-based needs, etc. The priority or urgency of a workload may be indicated in a request for executing the workload. The assignment can ensure compatibility and urgency. Each node combines the extrinsic property received locally with the shared intrinsic property during runtime, leveraging the management node 110 to ensure a compatibility match based on the workload requirements. This allows for efficient execution and optimal resource utilization by choosing the right nodes at the right time. Upon completion of the execution of the workload 122, the node(s) can send results (e.g., datasets, binary output, application programming interface (API) call, etc.) of the execution back to the management node 110 for consolidation. The management node 110 may then perform an action based on the results. For instance, the management node 110 may cause an output indicating the results to be displayed at a user interface of a user device.

In some examples, properties may switch between being intrinsic properties and extrinsic properties. For instance, if the management node 110 determines that a threshold percentage (e.g., 80%) of workload requests includes a particular extrinsic property (e.g., a dataset), the management node 110 may determine that the extrinsic property is to be changed to an intrinsic property. In this example, the dataset becoming an intrinsic property can mean that a node needs to be capable of receiving a dataset. So, while the type of dataset (e.g., data stream, API call, etc.) may remain an extrinsic property, the ability to receive a dataset can become an intrinsic property. The management node may alternatively determine that an intrinsic property is to be changed to an extrinsic property if the threshold percentage of requests do not include the intrinsic property.

While FIG. 1 depicts a specific arrangement of components, other examples can include more components, fewer components, different components, or a different arrangement of the components shown in FIG. 1. For instance, while FIG. 1 only shows two nodes, other examples may include a different number of nodes. Also, any component or combination of components depicted in FIG. 1 can be used to implement the process(es) described herein.

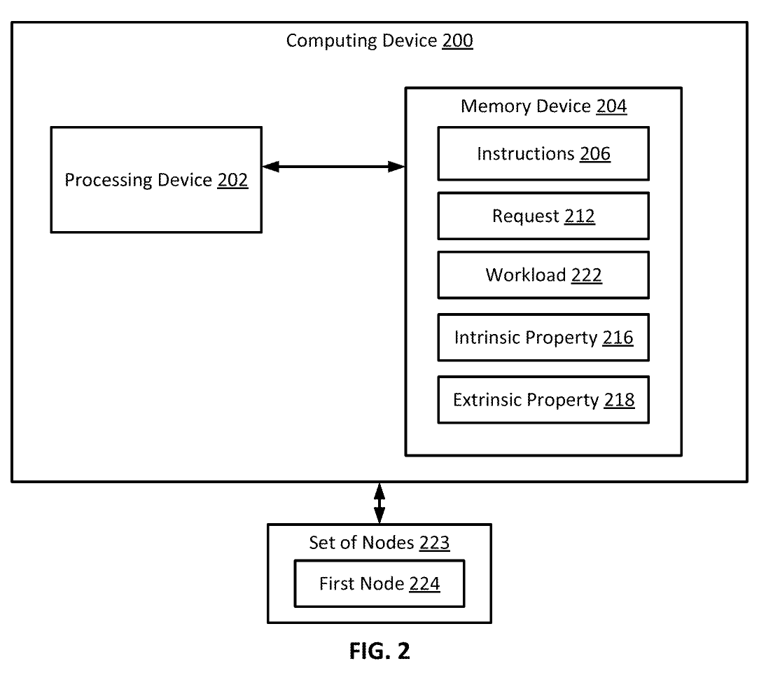

FIG. 2 is a block diagram of an example of a computing device for workload distribution based on node properties according to some examples of the present disclosure. The computing device 200 includes a processing device 202 communicatively coupled to a memory device 204. In some examples, the components of the computing device 200, such as the processing device 202 and the memory device 204, may be part of a same computing device, such as the management node 110 in FIG. 1. In other examples, the processing device 202 and the memory device 204 can be included in separate computing devices that are communicatively coupled.

The processing device 202 can include one processing device or multiple processing devices. Non-limiting examples of the processing device 202 can include a Field-Programmable Gate Array (FPGA), an application-specific integrated circuit (ASIC), and a microprocessor. The processing device 202 can execute instructions 206 stored in the memory device 204 to perform computing operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can include a non-transitory computer-readable medium from which the processing device 202 can read instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the processing device 202 can execute the instructions 206 to perform some or all of the functionality described herein. For example, the processing device 202 can receive a request 212 to execute a workload 222 on at least one node of a set of nodes 223. The processing device 202 can determine, based on the request 212, an intrinsic property 216 that a first node 224 of the set of nodes 223 is to include for executing the workload 222. The intrinsic property 216 can be independent of the workload 222. The processing device 202 can determine, based on the request 212, an extrinsic property 218 that is to be used by the node to execute the workload 222. The extrinsic property 218 can be dependent on the workload 222. The processing device 202 can determine that a first node 224 of the set of nodes 223 includes the intrinsic property 216. In response to determining that the first node 224 includes the intrinsic property 216, the processing device 202 can execute the workload 222 on the first node 224 using the extrinsic property 218. The first node 224 may include the extrinsic property 218 prior to executing the workload 222, or the processing device 202 may provide the extrinsic property 218 to the first node 224 at the time of the execution.

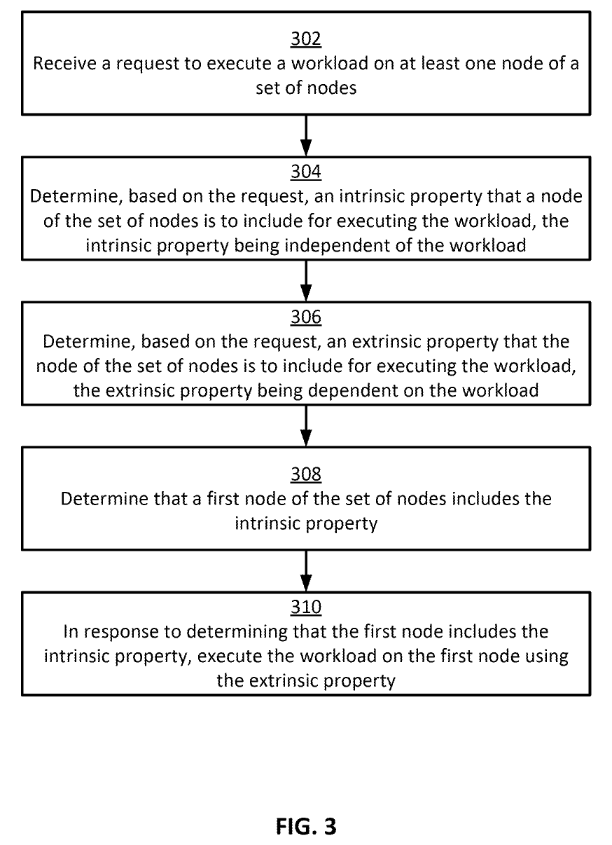

FIG. 3 is a flow chart of an example of a process for workload distribution based on node properties according to some examples of the present disclosure. In some examples, the processing device 202 can implement some or all of the steps shown in FIG. 3. Additionally, in some examples, the processing device 202 can be executing on or in communication with the control node 102 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can receive a request 212 to execute a workload 222 on at least one node of a set of nodes 223. The workload 222 may be a software application or other process. The request 212 may indicate a number of nodes of the set of nodes 223 that the workload 222 is to be executed on. For instance, the request 212 may indicate that the workload 222 is to be executed on one node. Executing the workload 222 on multiple nodes can reduce having a single point of failure in the system. In addition, the request 212 may include a flag or keyword indicating a priority or urgency of the workload.

At block 304, the processing device 202 can determine, based on the request 212, an intrinsic property 216 that a node of the set of nodes 223 is to include for executing the workload 222. The intrinsic property 216 can be independent of the workload 222. The request 212 can define requirements 114 for the workload 222, and the requirements 114 can indicate the intrinsic properties (e.g., node requirements) associated with the workload 222. For instance, the requirements 114 may indicate a type of node (e.g., a Raspberry Pi) for executing the workload 222, an amount of RAM for executing the workload 222, and a security key for executing the workload 222. Each of these requirements 114 can correspond to an intrinsic property.

At block 306, the processing device 202 can determine, based on the request 212, an extrinsic property 218 that the node of the set of nodes 223 is to include for executing the workload 222. The extrinsic property 218 can be dependent on the workload 222. The requirements 114 for the workload 222 can indicate extrinsic properties (e.g., deployable requirements) associated with the workload 222. For instance, the requirements 114 may indicate an algorithm for executing the workload 222, a geographic location for executing the workload 222, and a configuration file for executing the workload 222. Each of these requirements 114 can correspond to an extrinsic property.

At block 308, the processing device 202 can determine that a first node 224 of the set of nodes 223 includes the intrinsic property 216. The processing device 202 may receive manifests from each node of the set of nodes 223, where the manifests indicate the intrinsic properties included in each of the nodes. In some instances, the manifests may additionally indicate the extrinsic properties included in each of the nodes. The processing device 202 may store a list that indicates the intrinsic properties (and extrinsic properties) for each of the nodes. So, the processing device 202 can determine that the first node 224 includes the intrinsic property 216 based on the list.

At block 310, the processing device 202, in response to determining that the first node 224 includes the intrinsic property 216, can execute the workload 222 on the first node 224 using the extrinsic property 218. The processing device 202 may additionally determine that the first node 224 includes the extrinsic property 218 and that a second node that includes the intrinsic property 216 excludes the extrinsic property 218. So, the processing device 202 can prioritize the first node 224 higher than the second node for executing the workload 222. In addition, the processing device 202 may determine that the first node 224 lacks the extrinsic property 218, so the processing device 202 can provide the extrinsic property 218 to the first node 224 for use in executing the workload 222. Accordingly, the processing device 202 assigns workloads to nodes that result in efficient execution and optimal resource utilization for the workloads by leveraging resources that are available based on the requirements of the workloads.

In some examples, the processing device 202 may execute the workload 222 using multiple nodes. Each of the nodes that execute the workload 222 can include the intrinsic property 216. Multiple nodes may execute the workload 122 to remove variability in results of the execution and to remove a single point of failure. Upon completion of the execution of the workload 222, the first node 224, and any additional nodes that executed the workload 222 can send results of the execution to the processing device 202, which may cause an action based on the results.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device storing program code that is executable by the processing device for causing the processing device to perform operations including:
receiving a request to execute a workload on at least one node of a set of nodes;
determining, based on the request, an intrinsic property that a node of the set of nodes is to include for executing the workload, the intrinsic property being independent of the workload;
determining, based on the request, an extrinsic property that is to be used to execute the workload, the extrinsic property being dependent on the workload;
determining that a first node of the set of nodes includes the intrinsic property; and
in response to determining that the first node includes the intrinsic property, executing the workload on the first node using the extrinsic property.

2. The system of claim 1, wherein the operations further comprise:
determining a set of requirements for running the workload based on the request, wherein the set of requirements include node requirements and deployable requirements;
determining the intrinsic property based on the node requirements of the set of requirements; and
determining the extrinsic property based on the deployable requirements.

3. The system of claim 1, wherein the operations further comprise:
receiving, from each node of the set of nodes, a manifest indicating properties of the node;
determining a subset of the set of nodes having the intrinsic property based on the properties; and
selecting the first node from the subset of the set of nodes for executing the workload.

4. The system of claim 3, wherein the first node is selected based on a geographic location of the first node, a capacity of the first node, or a node selection algorithm.

5. The system of claim 1, wherein the operations further comprise:
determining that a plurality of nodes including at least the first node and a second node of the set of nodes includes the intrinsic property; and
executing the workload on the plurality of nodes using the extrinsic property.

6. The system of claim 5, wherein the operations further comprise:
determining that the request indicates a number of nodes for executing the workload; and
selecting the plurality of nodes based on the number of nodes.

7. The system of claim 1, wherein the operations further comprise:
determining that the first node lacks the extrinsic property; and
executing the workload on the first node by providing the extrinsic property to the first node.

8. A method comprising:
receiving a request to execute a workload on at least one node of a set of nodes;
determining, based on the request, an intrinsic property that a node of the set of nodes is to include for executing the workload, the intrinsic property being independent of the workload;
determining, based on the request, an extrinsic property that is to be used to execute the workload, the extrinsic property being dependent on the workload;
determining that a first node of the set of nodes includes the intrinsic property; and
in response to determining that the first node includes the intrinsic property, executing the workload on the first node using the extrinsic property.

9. The method of claim 8, further comprising:
determining a set of requirements for running the workload based on the request, wherein the set of requirements include node requirements and deployable requirements;
determining the intrinsic property based on the node requirements of the set of requirements; and
determining the extrinsic property based on the deployable requirements.

10. The method of claim 8, further comprising:
receiving, from each node of the set of nodes, a manifest indicating properties of the node;
determining a subset of the set of nodes having the intrinsic property based on the properties; and
selecting the first node from the subset of the set of nodes for executing the workload.

11. The method of claim 10, wherein the first node is selected based on a geographic location of the first node, a capacity of the first node, or a node selection algorithm.

12. The method of claim 8, further comprising:
determining that a plurality of nodes including at least the first node and a second node of the set of nodes includes the intrinsic property; and
executing the workload on the plurality of nodes using the extrinsic property.

13. The method of claim 12, further comprising:
determining that the request indicates a number of nodes for executing the workload; and
selecting the plurality of nodes based on the number of nodes.

14. The method of claim 8, further comprising:
determining that the first node lacks the extrinsic property; and
executing the workload on the first node by providing the extrinsic property to the first node.

15. A non-transitory computer-readable medium comprising program code that is executable by a processor for causing the processor to perform operations including:
receiving a request to execute a workload on at least one node of a set of nodes;
determining, based on the request, an intrinsic property that a node of the set of nodes is to include for executing the workload, the intrinsic property being independent of the workload;
determining, based on the request, an extrinsic property that is to be used to execute the workload, the extrinsic property being dependent on the workload;
determining that a first node of the set of nodes includes the intrinsic property; and
in response to determining that the first node includes the intrinsic property, executing the workload on the first node using the extrinsic property.

16. The non-transitory computer-readable medium of claim 15, further comprising:
determining a set of requirements for running the workload based on the request, wherein the set of requirements include node requirements and deployable requirements;
determining the intrinsic property based on the node requirements of the set of requirements; and
determining the extrinsic property based on the deployable requirements.

17. The non-transitory computer-readable medium of claim 15, wherein the operations further comprise:
receiving, from each node of the set of nodes, a manifest indicating properties of the node;
determining a subset of the set of nodes having the intrinsic property based on the properties; and
selecting the first node from the subset of the set of nodes for executing the workload.

18. The non-transitory computer-readable medium of claim 17, wherein the first node is selected based on a geographic location of the first node, a capacity of the first node, or a node selection algorithm.

19. The non-transitory computer-readable medium of claim 15, wherein the operations further comprise:
determining that a plurality of nodes including at least the first node and a second node of the set of nodes includes the intrinsic property; and
executing the workload on the plurality of nodes using the extrinsic property.

20. The non-transitory computer-readable medium of claim 19, wherein the operations further comprise:
determining that the request indicates a number of nodes for executing the workload; and
selecting the plurality of nodes based on the number of nodes.
